(19) United States
(12) Patent Application Publication
(10) Pub. No.: US 2022/0346173 A1
(43) Pub. Date: Oct. 27, 2022

(54) METHOD FOR TRANSMITTING AND RECEIVING SIGNAL FOR TERMINAL IN WIRELESS COMMUNICATION SYSTEM

(71) Applicant: LG ELECTRONICS INC., Seoul (KR)

(72) Inventors: Giwon PARK, Seoul (KR); Youngdae LEE, Seoul (KR); Jongyoul LEE, Seoul (KR)

(73) Assignee: LG ELECTRONICS INC., Seoul (KR)

(21) Appl. No.: 17/753,711

(22) PCT Filed: Sep. 17, 2020
(86) PCT No.: PCT/KR2020/012574

§ 371 Date: Mar. 11, 2022

(30) Foreign Application Priority Data
Sep. 17, 2019 (KR) 10-2019-0114255
Sep. 30, 2019 (KR) 10-2019-0120423

(51) Int. Cl. H04W 76/18; H04W 72/02; H04W 72/14

(52) U.S. Cl. CPC H04W 76/18; H04W 72/02; H04W 72/14; H04W 4/40

(57) ABSTRACT

One embodiment of a method, which is for a terminal operating in a wireless communication system, comprises the steps of: received configured grant from a serving cell; and reporting radio link failure (RLF) with the serving cell, wherein the terminal, subsequent to the RLF, perform sidelink communication using the configured grant until a new configured grant is received.

### TECHNICAL FIELD

The following description relates to a wireless communication system, and more specifically, to a method for performing sidelink communication by a UE using a configured grant.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A wireless communication system uses various radio access technologies (RATs) such as long term evolution (LTE), LTE-advanced (LTE-A), and wireless fidelity (WiFi). 5th generation (5G) is such a wireless communication system. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G

Finally, logistics and freight tracking are important use cases for mobile communications that enable the tracking of inventory and packages wherever they are by using location-based information systems. The logistics and freight tracking use cases typically require lower data rates but need wide coverage and reliable location information.

A wireless communication system is a multiple access system that supports communication of multiple users by sharing available system resources (a bandwidth, transmission power, etc.). Examples of multiple access systems include a CDMA system, an FDMA system, a TDMA system, an OFDMA system, an SC-FDMA system, and an MC-FDMA system.

Sidelink (SL) refers to a communication scheme in which a direct link is established between user equipments (UEs) and the UEs directly exchange voice or data without intervention of a base station (BS). SL is considered as a solution of relieving the BS of the constraint of rapidly growing data traffic.

Vehicle-to-everything (V2X) is a communication technology in which a vehicle exchanges information with another vehicle, a pedestrian, and infrastructure by wired/wireless communication. V2X may be categorized into four types: vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

As more and more communication devices demand larger communication capacities, there is a need for enhanced mobile broadband communication relative to existing RATs. Accordingly, a communication system is under discussion, for which services or UEs sensitive to reliability and latency are considered. The next-generation RAT in which eMBB, MTC, and URLLC are considered is referred to as new RAT or NR. In NR, V2X communication may also be supported.

FIG. 1 is a diagram illustrating V2X communication based on pre-NR RAT and V2X communication based on NR in comparison.

For V2X communication, a technique of providing safety service based on V2X messages such as basic safety message (BSM), cooperative awareness message (CAM), and decentralized environmental notification message (DENM) was mainly discussed in the pre-NR RAT. The V2X message may include location information, dynamic information, and attribute information. For example, a UE may transmit a CAM of a periodic message type and/or a DENM of an event-triggered type to another UE.

For example, the CAM may include basic vehicle information including dynamic state information such as a direction and a speed, vehicle static data such as dimensions, an external lighting state, path details, and so on. For example, the UE may broadcast the CAM which may have a latency less than 100 ms. For example, when an unexpected incident occurs, such as breakage or an accident of a vehicle, the UE may generate the DENM and transmit the DENM to another UE. For example, all vehicles within the transmission range of the UE may receive the CAM and/or the DENM. In this case, the DENM may have priority over the CAM.

In relation to V2X communication, various V2X scenarios are presented in NR. For example, the V2X scenarios include vehicle platooning, advanced driving, extended sensors, and remote driving.

For example, vehicles may be dynamically grouped and travel together based on vehicle platooning. For example, to perform platoon operations based on vehicle platooning, the vehicles of the group may receive periodic data from a leading vehicle. For example, the vehicles of the group may widen or narrow their gaps based on the periodic data.

For example, a vehicle may be semi-automated or full-automated based on advanced driving. For example, each vehicle may adjust a trajectory or maneuvering based on data obtained from a nearby vehicle and/or a nearby logical entity. For example, each vehicle may also share a dividing intention with nearby vehicles.

Based on extended sensors, for example, raw or processed data obtained through local sensor or live video data may be exchanged between vehicles, logical entities, UEs of pedestrians and/or V2X application servers. Accordingly, a vehicle may perceive an advanced environment relative to an environment perceivable by its sensor.

Based on remote driving, for example, a remote driver or a V2X application may operate or control a remote vehicle on behalf of a person incapable of driving or in a dangerous environment. For example, when a path may be predicted as in public transportation, cloud computing-based driving may be used in operating or controlling the remote vehicle. For example, access to a cloud-based back-end service platform may also be used for remote driving.

A scheme of specifying service requirements for various V2X scenarios including vehicle platooning, advanced driving, extended sensors, and remote driving is under discussion in NR-based V2X communication.

### DISCLOSURE

### Technical Task

A technical task of embodiment(s) is how long configured grant resources will be used when a UE using the configured grant resources announces radio link failure (RLF).

The technical task to be achieved in the embodiment(s) are not limited to the technical task mentioned above, and other technical tasks that are not mentioned can be clearly understood by those skilled in the art to which the embodiment(s) belong from the description below.

### Technical Solutions

One embodiment is a method for a UE operating in a wireless communication system, including receiving a configured grant from a serving cell, and announcing radio link failure (RLF) with respect to the serving cell, wherein the UE performs sidelink communication using the configured grant until receiving a new configured grant after the RLF.

One embodiment is a UE in a wireless communication system, including at least one processor, and at least one computer memory operably coupled to the at least one processor and storing instructions that, when executed, cause the at least one processor to perform operations, wherein the operations include receiving a configured grant from a serving cell, and announcing radio link failure (RLF) with respect to the serving cell, wherein the UE performs sidelink communication using the configured grant until receiving a new configured grant after the RLF.

One embodiment is a processor for performing operations for a UE in a wireless communication system, wherein the operations include receiving a configured grant from a serving cell, and announcing radio link failure (RLF) with respect to the serving cell, wherein the UE performs sidelink communication using the configured grant until receiving a new configured grant after the RLF.

One embodiment is a computer-readable storage medium storing at least one computer program including instructions that, when executed by at least one processor, cause the at least one processor to perform operations for a UE, wherein the operations include receiving a configured grant from a serving cell, and announcing radio link failure (RLF) with respect to the serving cell, wherein the UE performs sidelink communication using the configured grant until a new configured grant is received after the RLF.

The method may further include starting a radio link failure recovery timer, wherein the radio link failure recovery timer may be stopped based on the new configured grant.

The configured grant may be released based on a release indication.

The method may further include starting a radio link failure recovery timer, wherein the radio link failure recovery timer may be stopped based on the release indication.

The method may further include starting a radio link failure recovery timer, wherein the radio link failure recovery timer may be stopped based on recovery of a radio link.

The configured grant may include at least one of a configured grant type 1 and a configured grant type 2.

The UE may operate in a resource allocation mode 1.

The UE may switch to a resource allocation mode 2 when radio link recovery fails after the RLF.

The UE may release the configured grant when radio link recovery fails after the RLF.

The UE may communicate with at least one of another UE, a UE related to an autonomous vehicle, a base station or a network.

### Advantageous Effects

According to an embodiment, it is possible to perform sidelink communication seamlessly using configured grant resources even after RLF.

Effects that can be obtained in the embodiment(s) are not limited to the effects mentioned above, and other effects that are not mentioned can be clearly understood by those skilled in the art to which the embodiment(s) belong from the description below.

### DESCRIPTION OF DRAWINGS

The accompanying drawings, which are included to provide a further understanding of the disclosure, illustrate embodiments of the disclosure and together with the description serve to explain the principle of the disclosure. In the drawings:

FIG. 1 is a diagram illustrating vehicle-to-everything (V2X) communication based on pre-new radio access technology (NR) RAT and V2X communication based on NR in comparison;

FIG. 2 illustrates a radio protocol architecture for SL communication according to an embodiment of the present disclosure;

FIG. 3 illustrates UEs performing V2X or SL communication according to an embodiment of the present disclosure;

FIG. 4 illustrates resource units for V2X or SL communication according to an embodiment of the present disclosure;

FIG. 5 illustrates a procedure in which a UE performs V2X or SL communication according to a transmission mode according to an embodiment of the present disclosure;

FIG. 6 illustrates a flowchart of a method of detecting radio link failure (RLF);

FIGS. 7 to 20 are diagrams for illustrating embodiment(s); and

FIGS. 21 to 30 are diagrams for illustrating various devices to which embodiment(s) can be applied.

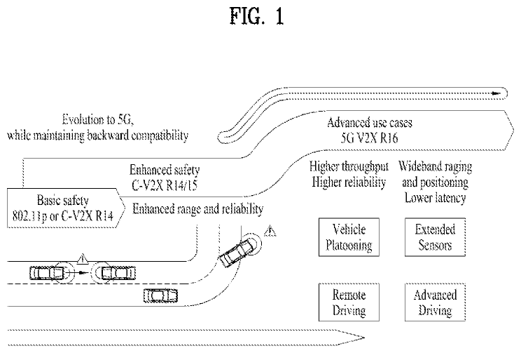

### BEST MODE FOR DISCLOSURE

In various embodiments of the present disclosure, “I” and “,” should be interpreted as “and/or”. For example, “A/B” may mean “A and/or B”. Further, “A, B” may mean “A and/or B”. Further, “A/B/C” may mean “at least one of A, B and/or C”. Further, “A, B, C” may mean “at least one of A, B and/or C”.

In various embodiments of the present disclosure, “or” should be interpreted as “and/or”. For example, “A or B” may include “only A”, “only B”, and/or “both A and B”. In other words, “or” should be interpreted as “additionally or alternatively”.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16e, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

A successor to LTE-A, 5th generation (5G) new radio access technology (NR) is a new clean-state mobile communication system characterized by high performance, low latency, and high availability. 5G NR may use all available spectral resources including a low frequency band below 1 GHz, an intermediate frequency band between 1 GHz and 10 GHz, and a high frequency (millimeter) band of 24 GHz or above.

While the following description is given mainly in the context of LTE-A or 5G NR for the clarity of description, the technical idea of an embodiment of the present disclosure is not limited thereto.

Hereinafter, V2X or sidelink (SL) communication will be described.

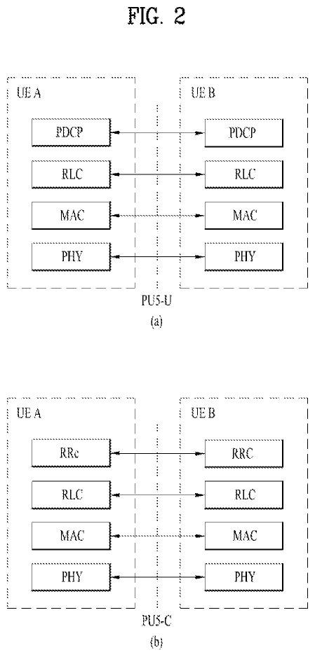

FIG. 2 shows a radio protocol architecture for SL communication according to an embodiment of the present disclosure. Specifically, (a) of FIG. 2 shows a user plane protocol stack of NR and (b) of FIG. 2 shows a control plane protocol stack of NR.

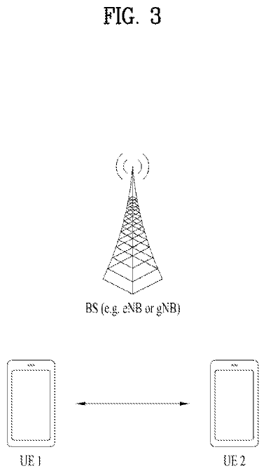

FIG. 3 illustrates UEs performing V2X or SL communication according to one embodiment of the present disclosure.

Referring to FIG. 3, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

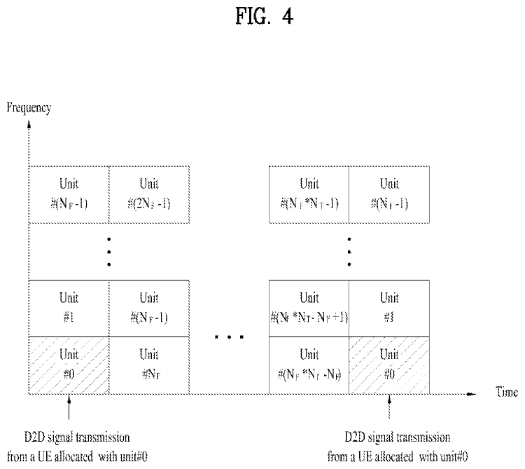

FIG. 4 illustrates resource units for V2X or SL communication.

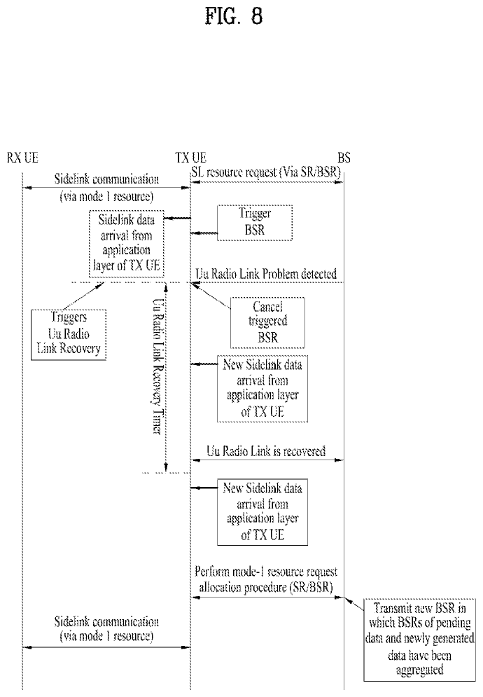

Referring to FIG. 4, the frequency resources of a resource pool may be divided into NF sets, and the time resources of the resource pool may be divided into NT sets. Accordingly, a total of NF*NT resource units may be defined in the resource pool. FIG. 8 shows an exemplary case where the resource pool is repeated with a periodicity of NT subframes.

As shown in FIG. 4, one resource unit (e.g., Unit #0) may appear periodically and repeatedly. Alternatively, in order to obtain a diversity effect in the time or frequency domain, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or a multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

Hereinafter, resource allocation in SL will be described.

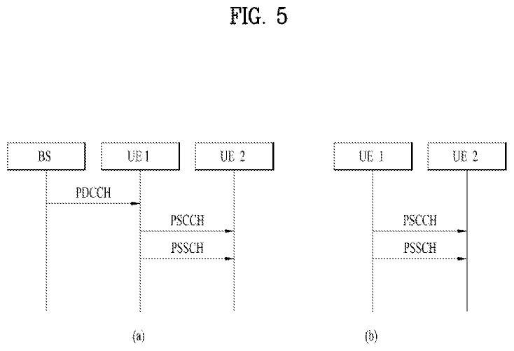

FIG. 5 shows a procedure in which a UE performs V2X or SL communication according to a transmission mode, according to an embodiment of the present disclosure. In various embodiments of the present disclosure, a transmission mode may be referred to as a mode or a resource allocation mode. Hereinafter, for convenience of description, a transmission mode in LTE may be referred to as an LTE transmission mode, and a transmission mode in NR may be referred to as an NR resource allocation mode.

For example, (a) of FIG. 5 shows a UE operation related to LTE transmission mode 1 or LTE transmission mode 3. For example, (a) of FIG. 5 shows a UE operation related to NR resource allocation mode 1. For example, LTE transmission mode 1 may be applied to general SL communication, and LTE transmission mode 3 may be applied to V2X communication.

For example, (b) of FIG. 5 shows a UE operation related to LTE transmission mode 2 or LTE transmission mode 4. For example, (b) of FIG. 5 shows a UE operation related to NR resource allocation mode 2.

Referring to (a) of FIG. 5, in LTE transmission mode 1, LTE transmission mode 3 or NR resource allocation mode 1, a BS may schedule SL resources to be used by a UE for SL transmission. For example, the BS may perform resource scheduling for UE 1 through a PDCCH (more specifically, downlink control information (DCI)), and UE 1 may perform V2X or SL communication with UE 2 according to resource scheduling. For example, UE 1 may transmit SCI (sidelink control information) to UE 2 through a physical sidelink control channel (PSCCH), and then transmit data based on the SCI to UE 2 through a physical sidelink shared channel (PSSCH).

For example, in NR resource allocation mode 1, the BS may provide or allocate resources for one or more SL transmissions in one transport block (TB) to a UE through a dynamic grant. For example, the BS may use a dynamic grant to provide resources for transmission of a PSCCH and/or a PSSCH to the UE. For example, a transmitting UE may report SL hybrid automatic repeat request (HARQ) feedback received from a receiving UE to the BS. In this case, PUCCH resources and timing for reporting the SL HARQ feedback to the BS may be determined based on an indication in a PDCCH for the BS to allocate resources for SL transmission.

For example, DCI may indicate a slot offset between DCI reception and first SL transmission scheduled by DCI. For example, a minimum gap between DCI scheduling SL transmission resources and first scheduled SL transmission resources may not be less than a processing time of the corresponding UE.

For example, in NR resource allocation mode 1, the BS may periodically provide or allocate a resource set to the UE through a configured grant for a plurality of SL transmissions. For example, the configured grant may include configured grant type 1 or configured grant type 2. For example, the UE may determine a TB to be transmitted on each occasion indicated by a given configured grant.

For example, the BS may allocate SL resources to the UE on the same carrier and may allocate SL resources to the UE on different carriers.

For example, an NR BS may control LTE-based SL communication. For example, the NR BS may transmit NR DCI to a UE to schedule LTE SL resources. In this case, for example, a new RNTI for scrambling the NR DCI may be defined. For example, the UE may include an NR SL module and an LTE SL module.

For example, after the UE including the NR SL module and the LTE SL module receives an NR SL DCI from a gNB, the NR SL module may convert the NR SL DCI into LTE DCI type 5A, and the NR SL module may deliver LTE DCI type 5A to the LTE SL module in X ms. For example, upon reception of LTE DCI format 5A from the NR SL module, the LTE SL module may apply activation and/or release to the first LTE subframe after Z ms. For example, X may be dynamically indicated using a field of DCI. For example, a minimum value of X may depend on UE capability. For example, the UE may report a single value according to UE capability. For example, X may be a positive number.

Referring to (b) of FIG. 5, in LTE transmission mode 2, LTE transmission mode 4 or NR resource allocation mode 2, a UE may determine SL transmission resources within SL resources configured by the BS/network or preset SL resources. For example, the configured SL resources or the preset SL resources may be a resource pool. For example, the UE may autonomously select or schedule resources for SL transmission. For example, the UE may perform SL communication by selecting resources by itself within a set resource pool. For example, the UE may select resources by itself within a selection window by performing a sensing and resource (re)selection procedure. For example, sensing may be performed in units of subchannels. In addition, UE 1, which has selected resources by itself within a resource pool, may transmit SCI to UE 2 through a PSCCH and transmit data based on the SCI to UE 2 through a PSSCH.

For example, a UE may help selection of SL resources for another UE. For example, in NR resource allocation mode 2, the UE may receive a configured grant for SL transmission. For example, in NR resource allocation mode 2, the UE may schedule SL transmission of another UE. For example, in NR resource allocation mode 2, the UE may reserve SL resources for blind retransmission.

For example, in NR resource allocation mode 2, a first UE may indicate the priority of SL transmission to a second UE using SCI. For example, the second UE may decode the SCI and perform sensing and/or resource (re)selection based on the priority. For example, the resource (re)selection procedure may include a step of identifying candidate resources in a resource selection window by the second UE and a step of selecting a resource for (re)transmission from among the identified candidate resources. For example, the resource selection window may be a time interval during which a UE selects a resource for SL transmission. For example, after the second UE triggers resource (re)selection, the resource selection window may start at T1≥0, and the resource selection window may be limited by a remaining packet delay budget. For example, in the step of identifying the candidate resources in the resource selection window by the second UE, the second UE may not determine a specific resource as a candidate resource if the specific resource is indicated by SCI received by the second UE from the first UE, and an L1 SL RSRP measurement value for the specific resource exceeds an SL RSRP threshold value. For example, the SL RSRP threshold value may be determined based on the priority of SL transmission indicated by the SCI received by the second UE from the first UE and the priority of SL transmission on the resource selected by the second UE.

For example, the L1 SL RSRP may be measured based on an SL demodulation reference signal (DMRS). For example, one or more PSSCH DMRS patterns may be configured or preset for each resource pool in the time domain. For example, PDSCH DMRS configuration type 1 and/or type 2 may be the same as or similar to the frequency domain pattern of the PSSCH DMRS. For example, the exact DMRS pattern may be indicated by SCI. For example, in NR resource allocation mode 2, a transmitting UE may select a specific DMRS pattern from among DMRS patterns configured or preset for a resource pool.

For example, in NR resource allocation mode 2, the transmitting UE may perform initial transmission of a transport block (TB) without reservation based on the sensing and resource (re)selection procedure. For example, the transmitting UE may reserve an SL resource for initial transmission of the second TB using SCI associated with the first TB based on the sensing and resource (re)selection procedure.

For example, in NR resource allocation mode 2, a UE may reserve resources for feedback-based PSSCH retransmission through signaling related to previous transmission of the same TB. For example, the maximum number of SL resources reserved by one transmission including current transmission may be 2, 3, or 4. For example, the maximum number of SL resources may be the same regardless of whether HARQ feedback is enabled. For example, the maximum number of HARQ (re)transmissions for one TB may be limited by configuration or pre-configuration. For example, the maximum number of HARQ (re)transmissions may be up to 32. For example, if there is no configuration or pre-configuration, the maximum number of HARQ (re)transmissions may be unspecified. For example, the configuration or pre-configuration may be for a transmitting UE. For example, in NR resource allocation mode 2, HARQ feedback for releasing resources that are not used by a UE may be supported.

For example, in NR resource allocation mode 2, a UE may indicate one or more subchannels and/or slots used by the UE to another UE by using SCI. For example, the UE may indicate one or more subchannels and/or slots reserved by the UE for PSSCH (re)transmission to another UE by using SCI. For example, the minimum allocation unit of SL resources may be a slot. For example, the size of a subchannel may be set for the UE or may be preset.

Hereinafter, radio link monitoring (RLM) and radio link failure (RLF) of an LTE system will be described.

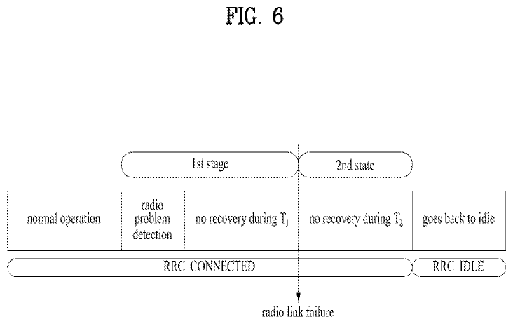

FIG. 6 is a flowchart of a method of detecting radio link failure (RLF).

A UE in a carrier aggregation system including a plurality of serving cells performs radio link monitoring (RLM) for a serving cell.

In the case of RLM, the UE may monitor the downlink radio link quality of the serving cell (e.g., primary cell (PCell)) based on a CRS. Specifically, the UE may estimate the radio link quality in a single subframe based on the CRS and monitor/evaluate a radio link state (e.g., out-of-sync or in-sync) by comparing the estimated value (e.g., a signal-to-noise ratio (SNR) or a signal-to-interference plus noise ratio (SINR)) to threshold values (Qout and Qin). If the radio link state is in-sync, the UE can perform/maintain normal communication with a BS, and if the radio link state is out-of-sync, the UE can consider that the radio link has failed and perform operations such as RRC connection re-establishment, handover, cell reselection, and cell measurement.

The physical layer of the UE monitors the downlink radio link quality of the serving cell (e.g., PCell) and informs a higher layer (e.g., RRC) of the out-of-sync/in-sync state. Specifically, when the radio link quality is better than Qin, the physical layer of the UE indicates in-sync to the higher layer in a radio frame in which the radio link quality is evaluated. The physical layer of the UE evaluates the radio link quality in every radio frame in a non-DRX mode, and the physical layer of the UE evaluates the radio link quality at least once in every DRX cycle in a DRX mode. When higher layer signaling indicates subframe(s) for restricted RLM, evaluation of radio link quality is not performed in non-indicated subframes. Thereafter, when the radio link quality is worse than Qout, the physical layer of the UE indicates out-of-sync to the higher layer in the radio frame in which the radio link quality is evaluated.

When the radio link state is in-sync, the UE may normally perform/maintain communication with the BS. When the radio link state is out-of-sync, the UE considers that radio link failure (RLF) has occurred for the radio link. When radio link failure (RLF) occurs with respect to the PCell, the procedure of the UE is performed in the same manner as in FIG. 6. As shown in FIG. 6, an operation related to radio link failure is performed in two stages.

The first stage begins upon detection of a radio link problem. This leads to radio link failure detection. In the first stage, there is no UE-based mobility and operation is based on timer T1.

The second stage begins upon detection of radio link failure or handover failure. This leads to an RRC_IDLE state. In the second stage, UE-based mobility is present and operation is based on timer T2.

In the second stage, in order for a UE to resume RRC connection (state) and to avoid transition to the RRC_IDLE state, the following procedure may be applied when the UE returns to the same cell in which radio link failure is detected, selects a cell different from the cell in which radio link failure is detected in the same BS, or selects a cell from another BS.

1. The UE maintains the RRC_CONNECTED state for time T2.

2. The UE accesses a cell through a random access procedure.

3. The BS identifies the UE using identification information or identity of the UE (e.g., C-RNTI of the UE in the cell in which RLF has occurred, the identity of the physical layer of the corresponding cell, a short MAC-I based on a security key of the corresponding cell, etc.) used in a collision resolution random access procedure and checks whether a stored context belongs to the UE. In this case, the identification information of the UE used in the collision resolution random access procedure may be information used for random access preamble transmission in the collision resolution random access procedure.

When the BS discovers that the stored context matches the identity of the corresponding UE in 3, the BS informs the UE that RRC connection of the UE can be restarted. On the other hand, when the BS does not discover the context, RRC connection between the UE and the BS is released, and the UE may start a procedure for establishing a new RRC connection. In this case, the UE switches to the RRC_IDLE state.

In summary, in the LTE system, the PDCCH/PCFICH is defined as a reference channel for RLM, and a communication quality threshold value for defining the In-Sycn/Out-of-sync state through the defined reference channel. At this time, since the PDCCH serving as the reference channel is not always transmitted, the UE performs RLM through a procedure of predicting the quality of the PDCCH through the SNR of the region in which the PDCCH is transmitted and comparing the same with a threshold value.

### EMBODIMENTS

In resource allocation mode 1, a dynamic grant, configured grant type 1, and configured grant type 2 for sidelink communication of a UE are supported. The UE may be allocated sidelink resources from a BS through the dynamic grant, configured grant type 1, or configured grant type 2. For example, the dynamic grant may be received through DCI by transmitting a scheduling request (SR)/buffer status report (BSR) of the UE. In addition, the UE may be provided or allocated a periodic resource set for transmission of a plurality of SLs from the BS through the configured grant type 1 and the configured grant type 2. For example, configured grant type 1 sidelink transmission may be semi-permanently scheduled by a higher layer signal without an activation process by DCI. Further, configured grant type 2 sidelink transmission may be activated or deactivated by DCI.

When a problem (e.g., beam failure or radio link failure) occurs in a Uu link between the UE and the BS in NR (New Radio) V2X (Vehicle-to-everything), the Uu radio link problem may also affect sidelink communication between V2X devices. If a problem occurs in the Uu radio link while a V2X UE is performing sidelink communication by receiving resources allocated from the BS in mode 1 method (i.e., mode 1 dynamic scheduling), the UE cannot normally perform “mode 1 resource allocation request (i.e., SR/BSR procedure)” for sidelink communication to the BS. In other words, if there is a problem in a link between the UE and the BS, the UE cannot perform a dynamic grant request operation by transmitting the SR/BSR.

Therefore, according to the embodiment (s) of the present disclosure, there are provided a method for managing sidelink transmission resources of a UE, a channel coding operation, and an apparatus supporting the same when a Uu radio link problem occurs in NR V2X.

Hereinafter, a radio link problem in a Uu link can be considered to have occurred in the following situations.
Uu beam failure
Uu physical layer problem (e.g., occurrence of continuous out of sync indication events)
Occurrence of one Uu physical layer problem event (e.g., occurrence of one out of sync indication event)
Uu radio link failure

Hereinafter, a Uu radio link recovery timer may be one of the timers below.
Uu beam failure recovery timer
Uu physical layer problem recovery timer
Uu radio link failure recovery timer

### 1. First Embodiment

1.1. Proposal 1

When a UE that performs sidelink communication by receiving sidelink transmission resources allocated from a BS based on SR/BSR transmission detects a Uu radio link problem, the UE can cancel all BSRs/SRs triggered for sidelink transmission.

1.2. Proposal 2

If a UE that performs sidelink communication by receiving sidelink transmission resources allocated from a BS based on SR/BSR transmission detects a Uu radio link problem, the UE can use configured grant type 2 to continue sidelink communication ceaselessly if the BS has configured grant type 2 resources for the UE through RRC signaling before detection of the Uu radio link problem, and the use of the configured grant type 2 resources is indicated (e.g., the BS activates the use of the configured grant type 2 resources through a physical layer, that is, DCI) before detection of the Uu radio link program (for example, a state in which the use of the configured grant type 2 resources has been instructed but SR/BSR-based SL resources are being used).

1.3. Proposal 3

If a UE that performs sidelink communication by receiving sidelink transmission resources allocated from a BS based on SR/BSR transmission detects a Uu radio link problem, the UE can use configured grant type 1 to continue sidelink communication ceaselessly until the following period if the BS has configured grant type 1 resources for the UE through RRC signaling before detection of the Uu radio link problem (e.g., a state in which the use of the configured grant type 1 resources has been configured but SR/BSR-based SL resources are being used).

For example, the UE may continue to perform sidelink communication using the configured grant type 1 resources even if the Uu radio link problem is recovered. The UE may perform sidelink communication using the configured grant type 1 resources, and if the configured grant type 1 resources do not satisfy the QoS (e.g., latency) and reliability of newly generated sidelink data, perform sidelink communication by being allocated SR/BSR-based SL transmission resources without using the configured grant type 1 resources.

In another embodiment, the UE uses the configured grant type 1 resources until recovery from the Uu radio link problem, and after recovery of the Uu radio link problem, the UE may request resources again based on SR/BSR and receive sidelink transmission resources from the BS. If the Uu radio link is not recovered before the Uu radio link recovery timer expires, the UE may perform sidelink transmission using an exception TX pool after the Uu radio link recovery timer expires.

1.4. Proposal 4

When a UE that performs sidelink communication by receiving sidelink transmission resources allocated from a BS based on SR/BSR transmission detects a Uu radio link problem, the UE can use configured grant type 2 to continue sidelink communication ceaselessly until the following period if the BS has configured grant type 2 resources for the UE through RRC signaling before detection of the Uu radio link problem, and the use of the configured grant type 2 resources is indicated (e.g., the BS activates the use of the configured grant type 2 resources through a physical layer, that is, DCI) before detection of the Uu radio link program (for example, a state in which the use of the configured grant type 2 resources has been instructed but SR/BSR-based SL resources are being used).

For example, the UE may continue to use the configured grant type 2 resources even if the Uu radio link problem is recovered to continue sidelink communication. The UE performs sidelink communication using the configured grant type 2 resources, and if the configured grant type 2 resources do not satisfy the QoS (e.g., latency and reliability) of newly generated sidelink data, the UE may perform sidelink communication by being allocated SR/BSR-based SL transmission resources without using the configured grant type 2 resources.

In another embodiment, the UE may use the configured grant type 2 resources until recovery from the Uu radio link problem, and after recovery from the Uu radio link problem, request resources again based on SR/BSR to be allocated sidelink transmission resources from the BS. If the Uu radio link is not recovered before the Uu radio link recovery timer expires, the UE may perform sidelink transmission using an exception TX pool after the Uu radio link recovery timer expires.

1.5. Proposal 5

When a radio link problem (e.g., Uu beam failure, Uu physical layer problem, or Uu radio link failure) occurs in a Uu link between a mode-1 UE and a BS and thus the radio link recovery procedure is performed, if a transmitting UE (TX UE) has sidelink data for transmission to a receiving UE (RX UE), BSR triggered for sidelink data transmission is canceled without pending until the radio link is recovered. In addition, when the radio link problem is recovered, a new BSR is triggered for sidelink data that has not been previously transmitted. If new sidelink data is generated while the radio link problem is recovered from, a new BSR in which the BSR for the previously unsent sidelink data and the BSR for the new sidelink data transmission are aggregated can be transmitted.

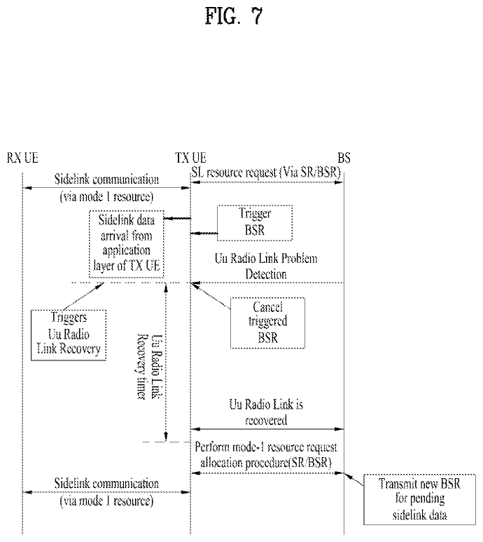

FIG. 7 is a diagram for illustrating embodiment(s) of the above-described proposal.

1. A transmitting UE may send a request for mode-1 sidelink transmission resources to a BS (based on SR/BSR) and receive the mode-1 resources to perform sidelink communication.

2. BSR may be triggered because new data to be transmitted by the transmitting UE to a receiving UE is generated.

3. The sidelink transmitting UE may detect a radio link problem in the Uu link (between the UE and the BS) and at the same time start a “Uu radio link recovery timer (e.g., a Uu beam failure recovery timer, a Uu physical layer problem recovery timer, or a Uu radio link failure recovery timer)”.

4. The transmitting UE may cancel the BSR triggered for sidelink data transmission.

5. The Uu radio link between the transmitting UE and the BS can be recovered.

6. The transmitting UE may trigger a new BSR for sidelink data that has not been transmitted.

7. The transmitting UE may recover from the Uu radio link problem and transmit a new BSR to the BS to receive a grant for sidelink data transmission from the BS.

FIG. 8 is a diagram for illustrating embodiment(s) of the above-described proposal.

1. The transmitting UE may request mode-1 sidelink transmission resources from the BS (based on SR/BSR) and receive the mode-1 resources to perform sidelink communication.

2. New data to be transmitted by the transmitting UE to the receiving UE is generated, and thus a BSR may be triggered.

3. The sidelink transmitting UE may detect a radio link problem in the Uu link (between the UE and the BS) and at the same time start “Uu radio link recovery timer (e.g., Uu beam failure recovery timer, Uu physical layer problem recovery timer, or Uu radio link failure recovery timer)”.

4. The transmitting UE may cancel the BSR triggered for sidelink data transmission.

5. The Uu radio link between the transmitting UE and the BS station can be recovered.

6. When the transmitting UE triggers a new BSR for sidelink data transmission that has not been performed, if new sidelink data is generated during Uu radio link recovery or after Uu radio link recovery, the transmitting UE may trigger a new BSR in which BSR information for sidelink data that has not been transmitted and BSR information for newly generated new sidelink data are aggregated.

For example, at the time of aggregating BSR information, BSR information for a plurality of pieces of sidelink data delivered to the same destination ID (e.g., new sidelink data to be transmitted to the same receiving UE (same destination ID) to which sidelink data that has not been previously transmitted) may be aggregated to trigger a new BSR.

In another embodiment, even if newly generated sidelink data is sidelink data delivered to a receiving UE having a different destination ID, BSR information for a plurality of pieces of sidelink data (e.g., new sidelink data for transmission to a different receiving UE (different destination ID) from the receiving UE to which sidelink data has not been previously transmitted) may be triggered to trigger a new BSR.

7. After Uu radio link recovery, the transmitting UE may transmit a new BSR to the BS to receive a grant for sidelink data transmission from the BS.

1.6. Proposal 6

When a radio link problem (e.g., Uu beam failure, Uu physical layer problem, or Uu radio link failure) occurs in a Uu link between a UE and a BS, mode-1 resource allocation is switched to mode-2 resource allocation only when proposed conditions are satisfied.

If there is sidelink data to be transmitted from a mode-1 transmitting UE to a receiving UE when a radio link problem occurs in the Uu link between the mode-1 UE and a BS, the transmitting UE may determine whether to continuously use mode-1 resources to perform sidelink communication or to switch mode 1 to mode 2 for sidelink communication using mode-2 resources according to the following conditions.

The transmitting UE may determine whether to continuously use the mode-1 resources or to switch to mode 2 to use the mode-2 resources by comparing a delay budget of data to be transmitted to the receiving UE with the duration of a Uu radio link recovery timer (e.g., a timer started by the UE because the Uu radio link recovery procedure is started due to the Uu radio link problem).
Condition used to determine whether to continuously use mode-1 resource allocation method or switch to mode-2 resource allocation method

1) Delay budget of arrival data of transmitting UE>Duration of Uu radio link recovery timer

(If (latency budget of arrival data of TX UE>Uu radio link recovery timer's duration))

(Scenario 1)

For example, when a Uu radio link problem is detected and thus the Uu radio link recovery procedure is triggered and the Uu radio link recovery timer is started, if a latency budget of sidelink data is longer than the Uu radio link recovery timer duration (that is, it is determined that there is a margin in delay for transmission of sidelink data), the transmitting UE can process the triggered BSR of sidelink arrival data as a pending BSR until recovery from the Uu radio link problem. In addition, the transmitting UE may hold the resource allocation process (mode-1 resource allocation and mode-2 resource allocation) until the Uu radio link is recovered. That is, the UE may not use the mode-2 TX exception pool as in the prior art (because there is a margin in the delay of the arrival data: that is, in that condition, latency requirement can be satisfied even if sidelink communication is resumed using mode-1 resources after recovery of the Uu radio link). In addition, when the Uu radio link is recovered, the transmitting UE may resume the pending BSR of the previous sidelink arrival data and perform a “mode-1 resource allocation request process (SR/BSR)” for the BS.

(Scenario 2)

In another embodiment, when a Uu radio link problem is detected and thus the Uu radio link recovery procedure is triggered and at the same time the Uu radio link recovery timer is started, if a latency budget of sidelink data is longer than the Uu radio link recovery timer duration (that is, it is determined that there is a margin in delay for transmission of sidelink data), the transmitting UE may cancel the triggered BSR of sidelink arrival data. In addition, the transmitting UE may hold the resource allocation process (mode-1 resource allocation and mode-2 resource allocation) until the Uu radio link is recovered. That is, the UE may not use the mode-2 TX exception pool as in the prior art (because there is a margin in the delay of the arrival data: that is, in that condition, latency requirement can be satisfied even if sidelink communication is resumed using mode-1 resources after recovery of the Uu radio link). When the Uu radio link is recovered, the transmitting UE may perform a “mode-1 resource allocation request process (SR/BSR)” by newly triggering the canceled BSR for transmission of previous sidelink arrival data.

(Scenario 3)

In another embodiment, if a latency budget of sidelink data is longer than the Uu radio link recovery timer duration (that is, it is determined that there is a margin in delay for transmission of sidelink data) when a Uu radio link problem is detected and thus the Uu radio link recovery procedure is triggered and at the same time the Uu radio link recovery timer is started, if sidelink data is generated after Uu radio link recovery starts, the transmitting UE may not trigger a BSR for the generated sidelink data. In addition, the transmitting UE may hold the resource allocation process (mode-1 resource allocation and mode-2 resource allocation) until recovery from the Uu radio link problem. That is, the UE may not use the mode-2 TX exception pool as in the prior art (because there is a margin in the delay of the arrival data: that is, in that condition, latency requirement can be satisfied even if sidelink communication is resumed using mode-1 resources after recovery of the Uu radio link). In addition, when the Uu radio link is recovered, the transmitting UE may perform a “mode-1 resource allocation request process (SR/BSR)” by triggering a BSR for transmission of previous sidelink arrival data.

In the above-described embodiment(s), if the Uu radio link is not recovered during the “Uu radio link recovery timer”, the UE may switch to mode 2, sense and select mode-2 resources, and transmit data to the receiving UE.

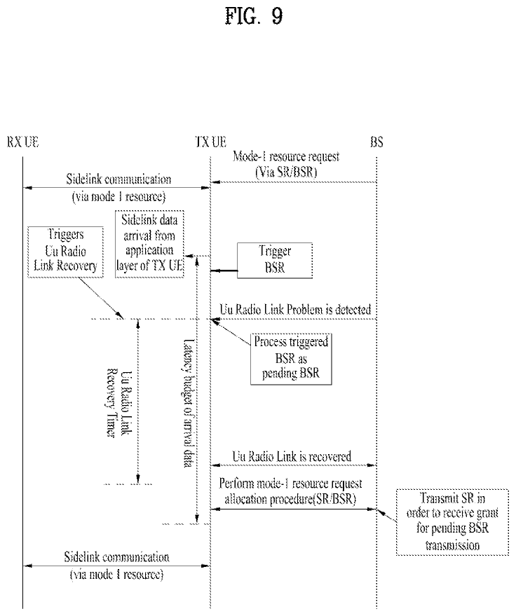

FIG. 9 is a diagram illustrating scenario 1 described above.

Referring to FIG. 9, the transmitting UE may operate as follows.

1. The transmitting UE may request mode-1 sidelink transmission resources from the BS (through SR/BSR) and receive the mode-1 resources to perform sidelink communication.

2. Data to be transmitted by the transmitting UE to the receiving UE is generated and thus a BSR may be triggered.

3. The sidelink transmitting UE may detect a radio link problem in the Uu link (between the UE and the BS), trigger Uu radio link recovery and at the same time start the “Uu radio link recovery timer”.

4. The transmitting UE may compare a delay budget of the generated sidelink data with the Uu radio link recovery timer duration, and when the delay budget of the sidelink data is longer than the Uu radio link recovery timer duration (that is, it is determined that there is a margin in the delay), process the triggered BSR as a pending BSR.

5. The transmitting UE may resume the pending BSR of previous sidelink data to resume the mode-1 resource allocation request process when the Uu radio link is recovered.

6. If the Uu radio link is not recovered during the Uu radio link recovery timer in the corresponding condition, the transmitting UE may switch to mode 2, sense and select mode-2 resources, and transmit sidelink data to the receiving UE.

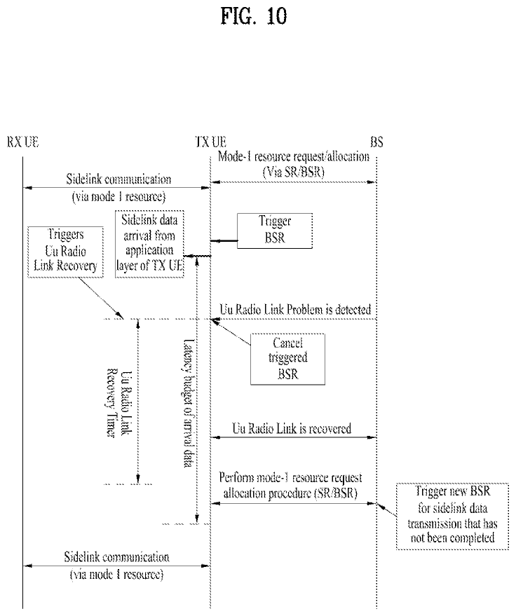

FIG. 10 is a diagram illustrating scenario 2 described above.

Referring to FIG. 10, the transmitting UE may operate as follows.

1. The transmitting UE may request mode-1 sidelink transmission resources from the BS (through SR/BSR) and receive the mode-1 resources to perform sidelink communication.

2. Data to be transmitted by the transmitting UE to the receiving UE is generated and thus a BSR may be triggered.

3. The sidelink transmitting UE may detect a radio link problem in the Uu link (between the UE and the BS), trigger Uu radio link recovery and at the same time start the Uu radio link recovery timer.

4. The transmitting UE may compare a delay budget of the generated sidelink data with the Uu radio link recovery timer, and when the delay budget of the sidelink data is longer than the Uu radio link recovery timer duration (that is, it is determined that there is a margin in the delay), cancel the triggered BSR.

5. The transmitting UE may trigger a new BSR for transmission of sidelink data that has not been transmitted to the previous receiving UE to perform the mode-1 resource allocation request process when the Uu radio link is recovered.

6. If the Uu radio link is not recovered during the Uu radio link recovery timer in the corresponding condition, the transmitting UE may switch to mode 2, sense and select mode-2 resources, and transmit sidelink data to the receiving UE.

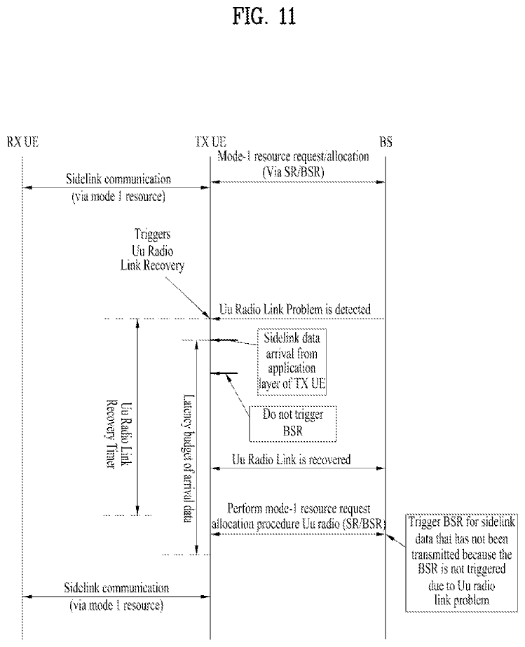

FIG. 11 is a diagram illustrating scenario 3 described above.

Referring to FIG. 11, the transmitting UE may operate as follows.

1. The transmitting UE may request mode-1 sidelink transmission resources from the BS (through SR/BSR) and receive the mode-1 resources to perform sidelink communication.

2. The sidelink transmitting UE may detect a radio link problem in the Uu link (between the UE and the BS), trigger Uu radio link recovery and at the same time start the “Uu radio link timer”.

3. Sidelink data that needs to be transmitted from the transmitting UE to the receiving UE may be generated.

4. The transmitting UE may compare a delay budget of the generated sidelink data with the Uu radio link recovery timer duration, and when the delay budget of the sidelink data is longer than the Uu radio link recovery timer duration (that is, it is determined that there is a margin in the delay), hold sidelink data transmission until the Uu radio link is recovered without triggering Uu radio link recovery for transmission of the generated sidelink data.

5. The transmitting UE may trigger a BSR for transmission of sidelink data that has not been transmitted to the previous receiving UE to perform the mode-1 resource allocation request process when the Uu radio link is recovered.

6. If the Uu radio link is not recovered during the Uu radio link recovery timer in the corresponding condition, the transmitting UE may switch to mode 2, sense and select mode-2 resources, and transmit sidelink data to the receiving UE.

2) Delay budget of arrival data of the TX UE<duration of Uu radio link recovery timer

(If (latency budget of arrival data of TX UE<Uu Radio Link Recovery Timer's duration))

(Scenario 4)

When a Uu radio link problem is detected and thus the Uu radio link recovery procedure is triggered, if a latency budget of sidelink data is shorter than the Uu radio link recovery timer duration (that is, it is determined that delay for transmission of sidelink data is short), the transmitting UE may cancel a triggered BSR of sidelink arrival data. In addition, when this condition is satisfied, the transmitting UE may use the mode-2 TX exception pool until the Uu radio link is recovered (because delay of arrival data is short: that is, in that state, latency requirement cannot be satisfied if sidelink communication is resumed using mode-1 resources after recovery of the Uu radio link). When the Uu radio link is recovered, the transmitting UE may resume the “mode-1 resource allocation request process (SR/BSR)” for transmission of new sidelink arrival data to transmit sidelink data to the receiving UE.

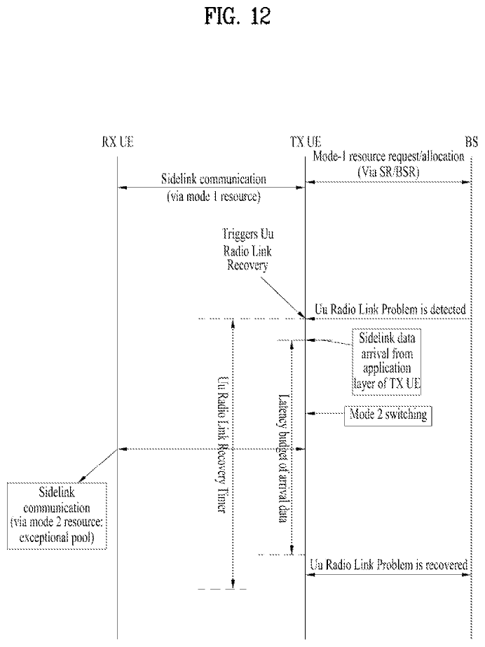

FIG. 12 is a diagram illustrating scenario 4 described above.

Referring to FIG. 12, the transmitting UE may operate as follows.

1. The transmitting UE may request mode-1 sidelink transmission resources from the BS (through SR/BSR) and receive the mode-1 resources to perform sidelink communication.

2. The sidelink transmitting UE may detect a radio link problem in the Uu link (between the UE and the BS), trigger Uu radio link recovery and at the same time start the “Uu radio link timer”.

3. Data to be transmitted from the transmitting UE to the receiving UE may be generated.

4. The transmitting UE may compare a delay budget of the generated sidelink data with the Uu radio link recovery timer, and when the delay budget of the sidelink data is shorter than the Uu radio link recovery timer duration (that is, it is determined that delay is short), use “mode-2 TX exception pool” until the Uu radio link is recovered.

5. When the Uu radio link is recovered, the transmitting UE may resume “mode-1 resource allocation request process (SR/BSR)” for transmission of new sidelink arrival data to transmit sidelink data to the receiving UE.

1.7. Proposal 7

When a V2X transmitting UE detects a Uu radio link problem (e.g., Uu beam failure, a Uu physical layer problem, or Uu radio link failure) and fails to use mode-1 resources and thus needs to perform a sensing operation in order to use “sensing based mode 2 resources” during Uu radio link recovery, “validity criterion (i.e., a reference time used for the transmitting UE to determine that corresponding resources are valid only when sensing is performed for a predefined time)” is applied differently.

For example, when the long-term sensing-based mode 2 resource selection method is used, it can be defined that only results of sensing performed by a transmitting UE for at least a time “M” are valid. On the other hand, when the short-term sensing-based mode 2 resource selection method is used, it can be defined that only results of sensing performed by a transmitting UE for at least a time “N” (N being defined as a time shorter than M. N<M. That is, it is defined that sensing results are determined to be valid even if sensing is performed for a shorter time than the sensing time applied to long-term sensing) are valid. That is, it can be defined such that the validity criterion of sensing results can be different depending on long-term sensing and short-term sensing.

1.8. Proposal 8

In the present disclosure, as a criterion for the transmitting UE to determine that a sensing result for using “mode-2 TX normal pool resource” is valid, “sensing should have been performed for a predefined sensing validity reference time (long-term sensing validity period or short-term sensing validity period), and at the same time, the corresponding sensing operation should be completed within a sidelink packet delay budget generated by the transmitting UE”.

In the following, a criterion for a UE to determine whether to use the “mode-2 TX exceptional pool” or the “mode-2 TX normal pool” during Uu radio link recovery by applying the aforementioned proposals 7 and 8 is proposed.

1.9. Proposal 9

When a V2X transmitting UE detects a radio link problem in a Uu link and fails to use mode-1 resources and thus needs to use mode-2 resources during Uu radio link recovery, if the transmitting UE has performed sensing during the validity criterion of proposal 1 and sensing is completed within a delay budget of sidelink data, “sensing-based mode-2 resources” can be used instead of random selection-based “mode-2 TX exception pool” during Uu radio link recovery.

1.10. Proposal 10

When a V2X transmitting UE detects a radio link problem in a Uu link and fails to use mode-1 resources and thus needs to use mode-2 resources during Uu radio link recovery, if the transmitting UE has performed sensing during the validity criterion of proposal 1 and sensing is not completed within a delay budget of sidelink data, random selection-based “mode-2 TX exception pool” can be used during Uu radio link recovery.

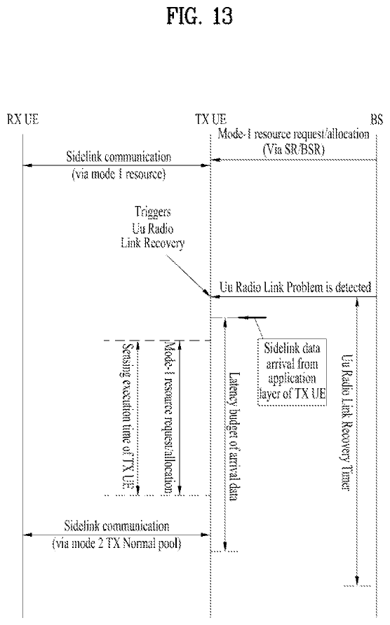

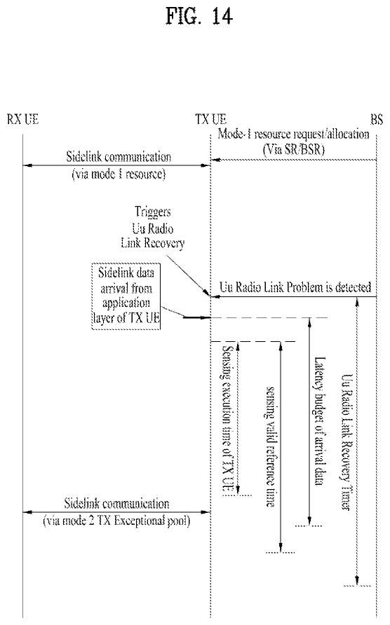

FIG. 13 and FIG. 14 illustrate embodiments in which a transmitting UE determines whether to use “sensing-based TX normal pool (mode-2 resource)” or “random selection-based TX exceptional pool (mode-2 resource)” during Uu radio link recovery to perform sidelink communication based on the proposals when the transmitting UE detects a radio link problem in a Uu link and thus starts the Uu radio link recovery procedure.

FIG. 13 is a diagram illustrating the above-mentioned proposal 9.

Referring to FIG. 13, when the Uu radio link recovery procedure starts, the transmitting UE may perform sidelink communication using “mode-2 TX normal pool” (i.e., by selecting and using sensing-based TX normal pool) during the Uu radio link recovery procedure when the transmitting UE has performed sensing for “sensing validity criterion of TX normal pool” proposed in the present disclosure, and completes sensing within a delay budget of sidelink data. The embodiment of FIG. 13 may be an embodiment in which the UE uses short-term sensing. The Uu radio link recovery timer mentioned in FIG. 13 may be a Uu beam failure recovery timer, a Uu physical layer problem recovery timer, or a Uu RLF recovery timer.

FIG. 14 is a diagram illustrating the above-mentioned proposal 10.

Referring to FIG. 14, when the Uu radio link recovery procedure starts, the transmitting UE may perform sidelink communication using “mode-2 TX exceptional pool” (i.e., by randomly selecting and using TX exceptional pool) during the Uu radio link recovery procedure when the transmitting UE cannot perform sensing for “sensing validity criterion of TX normal pool” proposed in the present disclosure (that is, when the transmitting UE cannot perform sensing for the validity reference time because execution of sensing for the sensing validity reference time exceeds the delay budget). The embodiment of FIG. 14 may be an embodiment in which the UE uses long-term sensing. The Uu radio link recovery timer mentioned in FIG. 14 may be a Uu beam failure recovery timer, a Uu physical layer problem recovery timer, or a Uu RLF recovery timer.

1.11. Proposal 11

When a radio link problem (e.g., Uu beam failure, a Uu physical layer problem, or Uu radio link failure) occurs in a Uu link between a mode-1 UE operating in the dynamic scheduling mode and a BS, if there is a configured grant resource configured by the BS, SL communication can be performed using the configured grant resource during Uu radio link recovery.

When the proposal is further extended, it can be applied as follows.

Method of using configured grant type-1 resources in order to continue sidelink communication when Uu radio link problem occurs

A mode-1 UE may include information on a sidelink service or sidelink data thereof (QoS information of sidelink data (priority), latency requirement, reliability requirement, destination UE address information, etc.) in a sidelinkUEInformation message and transmit the same to the BS for sidelink communication. The BS transmits grant type-1 resource information (e.g., resource location (time/frequency), resource period/offset information, etc.) configured for the UE based on the sidelinkUEInformation information received from the UE (through a dedicated RRC message). If the UE operating in the dynamic scheduling mode detects a Uu radio link problem, the UE may use the configured grant type-1 resource received from the BS through the dedicated RRC message in order to continue link communication.

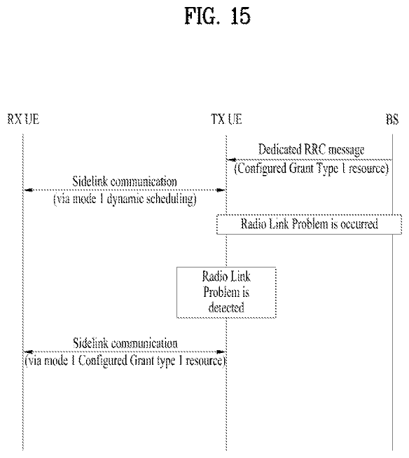

FIG. 15 is a diagram illustrating a method of using a configured grant type-1 resource when a radio link problem occurs in a Uu link.

Referring to FIG. 15, a transmitting UE may operate as follows.

1. The transmitting UE is allocated a configured grant type-1 resource from a BS through a dedicated RRC message.

2. The transmitting UE may perform sidelink communication in the dynamic scheduling mode.

3. A radio link problem may occur in the Uu link of the transmitting UE.

4. The transmitting UE may continuously perform sidelink communication using the configured grant type-1 resource received from the BS.

Method of using configured grant type-1 resources in order to continue sidelink communication when Uu radio link problem occurs

A mode-1 UE may include information on a sidelink service or sidelink data thereof (QoS information of sidelink data (priority), latency requirement, reliability requirement, destination UE address information, etc.) in a sidelinkUEInformation message and transmit the same to the BS for sidelink communication. The BS transmits grant type-2 resource information (e.g., resource location (time/frequency), resource period/power control parameter information, etc.) configured for the UE based on the sidelinkUEInformation information received from the UE (through a dedicated RRC message). If the BS detects a problem in the Uu radio link to the UE operating in the dynamic scheduling mode, the BS may transmit information (e.g., an offset with respect to the initial transmission timing, time/frequency resource allocation, a DMRS parameter, and MCS) to the UE operating in the dynamic scheduling mode through layer-1 signaling (DCI) to instruct the UE to perform sidelink communication using the configured grant type-2 resource. The BS may determine the Uu radio link problem based on a Uu measurement report value reported by the UE.

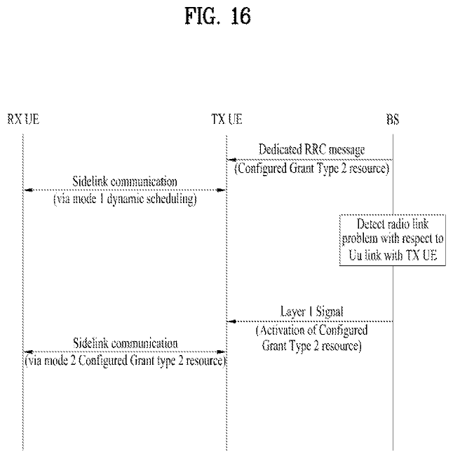

FIG. 16 is a diagram illustrating a method of using a configured grant type-2 resource when a radio link problem occurs in a Uu link.

Referring to FIG. 16, a transmitting UE may operate as follows.

1. The transmitting UE may be allocated a configured grant type-2 resource from a BS through a dedicated RRC message.

2. The transmitting UE may perform sidelink communication in the dynamic scheduling mode.

3. The BS may detect a radio link problem in the Uu link.

4. The BS may activate use of the grant type-2 resource configured for the UE operating in the dynamic scheduling mode through Layer-1 signaling (DCI) via the Uu link from which the radio link problem has been detected.

5. The transmitting UE may continue to perform sidelink communication using the configured grant type-2 resource activated by the BS through L1 signaling.

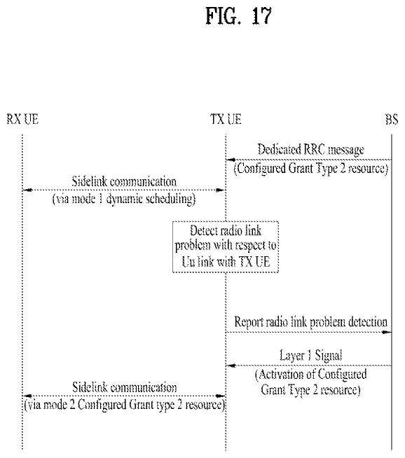

As another embodiment, FIG. 17 illustrates an embodiment in which a UE allocated a configured grant type-2 resource detects a radio link problem and reports the radio link problem to a BS, and the BS activates the grant type-2 resource configured for the UE. When a Uu radio link problem occurs, a UE operating in the dynamic scheduling mode, which has received the configured grant type-2 resource from the BS, cannot use the configured grant type-2 resource (because, if a Uu radio link problem occurs, the BS cannot activate the configured grant type-2 resource in the UE). In this proposal, upon detection of a Uu radio link problem, the UE that has received the configured grant type-2 resource reports the Uu radio link problem to the BS such that the BS can activate the grant type-2 resource configured for the UE.

Referring to FIG. 17, a transmitting UE may operate as follows.

1. The transmitting UE may be allocated a configured grant type-2 resource from a BS through a dedicated RRC message.

2. The transmitting UE may perform sidelink communication in the dynamic scheduling mode.

3. The UE may detect a radio link problem in the Uu link.

4. The UE that has received the configured grant type-2 resource may report the Uu radio link problem to the BS.

5. The BS may activate use of the configured grant type-2 resource for the UE through Layer-1 signaling (DCI).

6. The transmitting UE may continue to perform sidelink communication using the configured grant type-2 resource activated by the BS through L1 signaling.

According to the embodiment(s) of the present disclosure, even if a BS cannot allocate sidelink transmission resources to a UE due to detection of a Uu radio link problem (i.e., a problem in a radio link between the UE and the BS), the UE can perform sidelink communication ceaselessly using alternative resources mentioned in this proposal.

### 2. Second Embodiment

When there is a configured grant resource (configured grant type 1 or configured grant type 2) configured by a BS, a UE may continue to perform sidelink communication using the configured grant resource of mode 1. However, it is not yet defined how long grant resources configured in the standard will be used. In the present disclosure, how long a configured grant resource will be used when a Uu radio link problem occurs is defined, and a method of using the configured grant resource based thereon is proposed.

2.1. Proposal 1

While a Uu radio link problem occurs and thus a Uu radio link is recovered (during a Uu radio link recovery timer operation), a UE may use a configured grant resource previously configured (i.e., before the Uu radio link problem occurs) by a serving cell. According to the proposal of the present disclosure, the UE can operate using sidelink resources while the Uu radio link is recovered (i.e., during the Uu radio link recovery timer operation).

2.1.1. Proposal 1.1 While a Uu radio link problem occurs and thus a Uu radio link is recovered (during a Uu radio link recovery timer operation), a UE may use a configured grant resource previously configured (i.e., before the Uu radio link problem occurs) by a serving cell.

2.1.2. Proposal 1.2 While a Uu radio link problem occurs and thus a Uu radio link is recovered (during a Uu radio link recovery timer operation), the UE may continuously use a configured grant resource previously configured (i.e., before the Uu radio link problem occurs) by the serving cell until a new configured grant (configured grant type 1, or configured grant type 2) resource is received from the serving cell or a target cell. Even if the recovery timer is not set, the UE may continuously use a configured grant resource previously configured (i.e., before the Uu radio link problem occurs) by the serving cell until a new configured grant (configured grant type 1, or configured grant type 2) resource is received from the serving cell or the target cell.

2.1.3. Proposal 1.3 While a Uu radio link problem occurs and thus a Uu radio link is recovered (during a Uu radio link recovery timer operation), the UE may use a configured grant resource previously configured (i.e., before the Uu radio link problem occurs) by the serving cell, and when a new configured grant (configured grant type 1 or configured grant type 2) resource is configured by the serving cell or a target cell, stop the Uu radio link recovery timer and use the grant resource newly configured by the serving cell or the target cell.

2.1.4. Proposal 1.4 While a Uu radio link problem occurs and thus a Uu radio link is recovered (during a Uu radio link recovery timer operation), the UE may use a configured grant resource previously configured (i.e., before the Uu radio link problem occurs) by the serving cell, and when the serving cell or the target cell indicates releases or deactivation of the configured grant (configured grant type 1, or configured grant type 2) resource previously configured by the serving cell (i.e., before the Uu radio link problem occurs), stop the Uu radio link recovery timer. When the timer is stopped, the UE may use a resource based on mode-1 dynamic scheduling (SR/BSR-based resource allocation) or may switch to mode 2 and use the Mode 2 TX pool.

2.1.5. Proposal 1.5 While a Uu radio link problem occurs and thus a Uu radio link is recovered (during a Uu radio link recovery timer operation), the UE may use a configured grant resource previously configured (i.e., before the Uu radio link problem occurs) by the serving cell, and when a new configured grant (configured grant type 1 or configured grant type 2) resource is not configured by the serving cell or the target cell, stop the Uu radio link recovery timer, switch to the mode 2 and perform sidelink communication using the mode-2 TX pool.

2.1.6. Proposed 1.6 When a Uu radio link problem occurs and thus Uu radio link recovery is performed, but the Uu radio link is not recovered and recovery fails (i.e., during the Uu radio link recovery timer operation), the UE may deactivate or release the configured grant (configured grant type 1 or configured grant type 2) resource previously configured by the serving cell. Alternatively, the UE may switch to mode 2 and perform sidelink communication using the mode-2 TX pool (e.g., when there is a valid mode-2 TX resource pool) or perform sidelink communication using the exceptional pool (e.g., when there is no valid mode-2 TX resource pool).

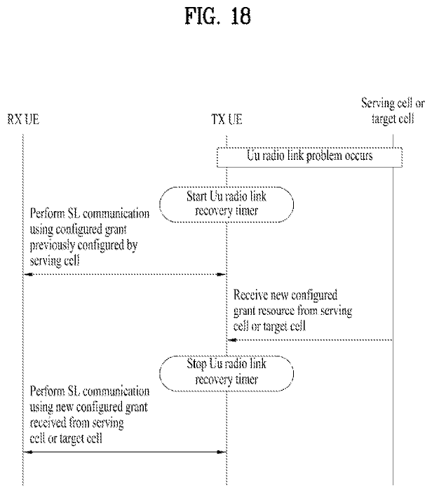

FIG. 18 is a diagram illustrating the above-described 2.1.3 proposal 1.3.

Referring to FIG. 18, a transmitting UE may start a radio link recovery upon occurrence of a radio link problem. In addition, the transmitting UE may perform sidelink communication using a configured grant previously configured by a serving cell even after the radio link recovery timer starts. Thereafter, the transmitting UE may receive a newly configured grant resource from the serving cell or a target cell and stop the radio link recovery timer. In addition, the transmitting UE may perform sidelink communication using the newly configured grant resource.

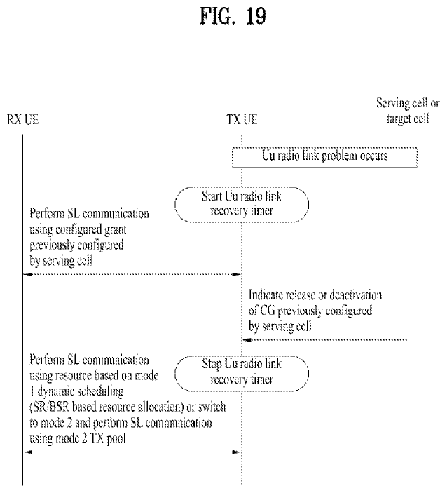

FIG. 19 is a diagram illustrating the above-described 2.1.4. proposal 1.4.

Referring to FIG. 19, a transmitting UE may start a radio link recovery timer upon occurrence of a radio link problem. In addition, the transmitting UE may perform sidelink communication using a configured grant previously configured by a serving cell even after the radio link recovery timer starts. Thereafter, the transmitting UE may receive indication of release or deactivation of the previously configured grant. Then, the transmitting UE may stop the radio link recovery timer, use a resource based on dynamic allocation, or switch to mode 2 to perform sidelink communication.

2.2 Proposal 2

While a Uu radio link problem occurs and thus a Uu radio link is recovered (during a Uu radio link recovery timer operation), a UE may use a configured grant resource previously configured (i.e., before the Uu radio link problem occurs) by a serving cell. When the Uu radio link is recovered (the Uu radio link recovery timer is stopped: the timer can be stopped when the Uu radio link problem is recovered), the UE needs to determine whether to continuously use the configured grant resource that is being used or to use a resource based on dynamic scheduling (SR/BSR-based resource allocation). In the present disclosure, even if the Uu radio link is recovered, the UE can continuously use the configured grant (configured grant type 1 or configured grant type 2) resource that is being used before a new configured grant (configured grant type 1 or configured grant type 2) is received from the serving cell or a target cell.

2.2.1. Proposal 2.1 When a Uu radio link problem occurs, Uu radio link recovery (i.e., Uu radio link recovery timer operation) is performed, and a Uu radio link is recovered, a UE may stop the Uu radio link recovery timer and continuously use configured grant (configured grant type 1 or configured grant type 2) resources previously configured (before the Uu radio link problem occurs) by a serving cell.

2.2.2. Proposal 2.2 When a Uu radio link problem occurs, Uu radio link recovery (i.e., Uu radio link recovery timer operation) is performed, and a Uu radio link is recovered, a UE may stop the Uu radio link recovery timer. In addition, the UE may continuously use a configured grant resource previously configured (before the Uu radio link problem occurs) by a serving cell until a new configured grant (configured grant type 1 or configured grant type 2) resource is received from the serving cell or a target cell. Even if the recovery timer is not set, the UE may continuously use the configured grant resource previously configured (before the Uu radio link problem occurs) by the serving cell until a new configured grant (configured grant type 1 or configured grant type 2) resource is received from the serving cell or a target cell.

2.2.3. Proposal 2.3 When a Uu radio link problem occurs, Uu radio link recovery (i.e., Uu radio link recovery timer operation) is performed, and a Uu radio link is recovered, a UE may stop the Uu radio link recovery timer. Thereafter, the UE uses a configured grant resource previously configured (that is, before the Uu radio link problem occurs) by the serving cell, and when a new configured grant (configured grant type 1 or configured grant type 2) resource is received from the serving cell or a target cell, use the newly set configured grant resource received from the serving cell or the target cell.

2.2.4. Proposed 2.4 When a Uu radio link problem occurs, Uu radio link recovery (i.e., Uu radio link recovery timer operation) is performed, and a Uu radio link is recovered, a UE may stop the Uu radio link recovery timer. Thereafter, the UE may use a configured grant resource previously configured from the serving cell (that is, before the Uu radio link problem occurs). When the serving cell or a target cell indicates releases or deactivation of the configured grant (configured grant type 1 or configured grant type 2) resource previously configured by the serving cell (that is, before the Uu radio link problem occurs), the UE may use a resource based on mode-1 dynamic scheduling (SR/BSR-based resource allocation) or switch to mode 2 and use a mode-2 TX pool.

2.2.5. Proposal 2.5 When a Uu radio link problem occurs, Uu radio link recovery (i.e., Uu radio link recovery timer operation) is performed, and a Uu radio link is recovered, a UE may stop the Uu radio link recovery timer. If a new configured grant (configured grant type 1 or configured grant type 2) resource is not received from the serving cell or a target cell until the Uu radio link is recovered, the UE may switch to mode 2 and perform sidelink communication using the mode-2 TX pool. Alternatively, if a new configured grant (configured grant type 1 or configured grant type 2) resource is not received from the serving cell or a target cell until the Uu radio link is recovered, the UE may continuously use a configured grant resource previously configured (i.e., before the Uu radio link problem occurs) by the serving cell.

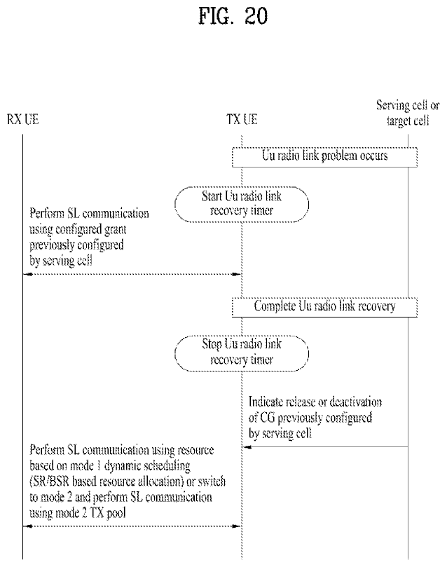

FIG. 20 is a diagram illustrating the above-described 2.2.4 proposal 2.4.

Referring to FIG. 20, a transmitting UE may start a radio link recovery timer upon occurrence of a radio link problem. In addition, the transmitting UE may perform sidelink communication using a configured grant previously configured by a serving cell even after the radio link recovery timer starts. After radio link recovery is completed, release or deactivation of the previously configured grant may be indicated. Then, the transmitting UE may perform sidelink communication by using a resource based on dynamic scheduling or by switching to mode 2.

According to the embodiment(s) of the present disclosure, even if a problem in a Uu radio link (that is, a radio link between a UE and a BS) is detected and thus the UE is no longer allocated a sidelink transmission resource from the BS, the UE may use an alternative resource (a mode 1 configured grant resource, or a mode 2 TX Pool) proposed in the present disclosure to continuously maintain sidelink communication.

Since examples of the above-described proposals can also be used as implementation methods of the present disclosure, it will also be apparent that the examples of the above-described proposals may be considered to be a kind of proposed methods. Although the above-described proposals can be implemented independently from each other, it should be noted that the above-described proposals can also be implemented as a combination (or a merged format) of some proposals. For example, although the proposed method has been disclosed based on the 3GPP NR system for convenience of description, a system to which the proposed method is applied may also be extended to another system other than the 3GPP NR system. For example, the proposed methods of the present disclosure may also be extendedly applied for D2D communication. Here, D2D communication indicates that a UE communicates with a different UE directly using a radio channel. Herein, although the UE refers to a user equipment (UE), when a network device such as a BS (or eNB) transmits and/or receives a signal according to a communication scheme between UEs, the UE may also be regarded as a sort of the UE. In addition, the proposed methods of the present disclosure may be limitedly applied only to MODE 3 V2X operation (and/or MODE 4 V2X operation). In addition, the proposed methods of the present disclosure may be limitedly applied only to a preconfigured (/signaled) (specific) V2X channel (/signal) transmission (e.g., PSSCH (and/or (interlinked) PSCCH and/or PSBCH)). In addition, the proposed methods of the present disclosure may be limitedly applied only to the case that a PSSCH and an (interlinked) PSCCH are adjacently (and/or non-adjacently) transmitted (on a frequency domain) (and/or a transmission based on a preconfigured (/signaled) MCS (and/or coding rate and/or resource block) (value (/range)) is performed). In addition, the proposed methods of the present disclosure may be limitedly applied only to MODE #3 (and/or MODE #4) V2X carrier (and/or (MODE #4 (/3) sidelink (/uplink) SPS (and/or sidelink (/uplink) dynamic scheduling) carrier). In addition, the proposed methods of the present document may be (limitedly) applied only if a synchronization signal (transmission (and/or reception)) resource position and/or a number (and/or V2X resource pool-related subframe position and/or number (and/or subchannel size and/or number)) are the same (and/or (some) different) between carriers. As an example, the proposed schemes of the present invention can be extended and applied to V2X communication between the BS and the UE. For example, the proposed schemes of the present disclosure may be limited only to UNICAST (sidelink) communication (and/or MULTICAST (or GROUPCAST) (sidelink) communication and/or BROADCAST (sidelink) communication).

Examples of Communication Systems Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices

Hereinafter, a description will be given in more detail with reference to the drawings. In the following drawings/description, the same reference symbols may denote the same or corresponding hardware blocks, software blocks, or functional blocks unless described otherwise.

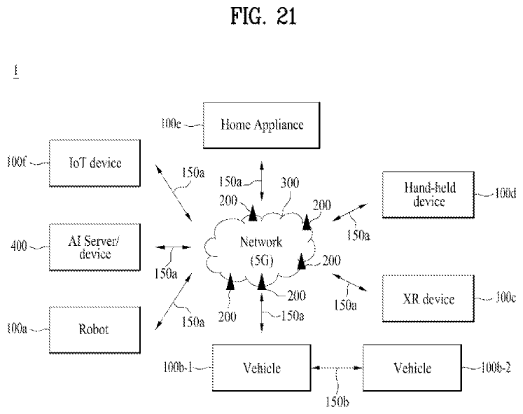

FIG. 21 illustrates a communication system applied to the present disclosure.

Referring to FIG. 21, a communication system applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Example of Wireless Devices to which the Present Disclosure is Applied

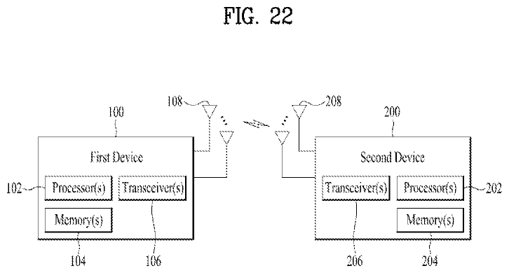

FIG. 22 illustrates wireless devices applicable to the present disclosure.

Referring to FIG. 22, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 21.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Here, wireless communication technologies implemented in the wireless devices (XXX, YYY) of the present disclosure may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present disclosure may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present disclosure is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

Example of a Signal Process Circuit to which the Present Disclosure is Applied

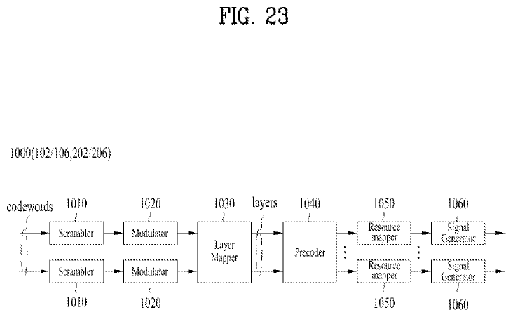

FIG. 23 illustrates a signal process circuit for a transmission signal.

Referring to FIG. 23, a signal processing circuit 1000 may include scramblers 1010, modulators 1020, a layer mapper 1030, a precoder 1040, resource mappers 1050, and signal generators 1060. An operation/function of FIG. 23 may be performed, without being limited to, the processors 102 and 202 and/or the transceivers 106 and 206 of FIG. 22. Hardware elements of FIG. 23 may be implemented by the processors 102 and 202 and/or the transceivers 106 and 206 of FIG. 22. For example, blocks 1010 to 1060 may be implemented by the processors 102 and 202 of FIG. 22. Alternatively, the blocks 1010 to 1050 may be implemented by the processors 102 and 202 of FIG. 22 and the block 1060 may be implemented by the transceivers 106 and 206 of FIG. 22.

Codewords may be converted into radio signals via the signal processing circuit 1000 of FIG. 23. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 23. For example, the wireless devices (e.g., 100 and 200 of FIG. 22) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Application Example of a Wireless Device to which the Present Disclosure is Applied

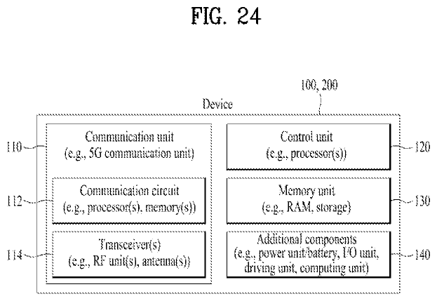

FIG. 24 illustrates another example of a wireless device applied to the present disclosure. The wireless device may be implemented in various forms according to a use-case/service (refer to FIG. 21).

Referring to FIG. 24, wireless devices 100 and 200 may correspond to the wireless devices 100 and 200 of FIG. 22 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 22. For example, the transceiver(s) 114 may include the one or more transceivers 106 and 206 and/or the one or more antennas 108 and 208 of FIG. 22. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 21), the vehicles (100b-1 and 100b-2 of FIG. 21), the XR device (100c of FIG. 21), the hand-held device (100d of FIG. 21), the home appliance (100e of FIG. 21), the IoT device (100f of FIG. 21), a digital broadcast UE, a hologram device, a public safety device, an MTC device, a medicine device, a fintech device (or a finance device), a security device, a climate/environment device, the AI server/device (400 of FIG. 21), the BSs (200 of FIG. 21), a network node, etc. The wireless device may be used in a mobile or fixed place according to a use-example/service.

In FIG. 24, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 24 will be described in detail with reference to the drawings.

Example of Hand-Held Device to which the Present Disclosure is Applied

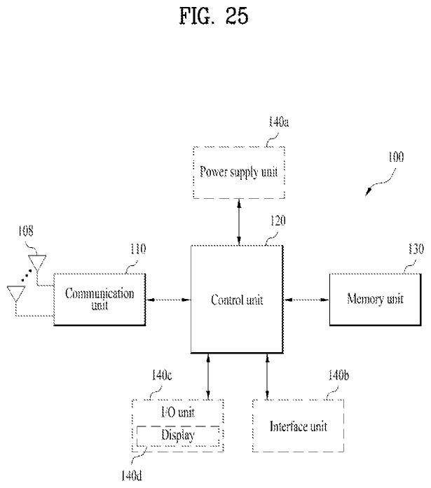

FIG. 25 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user UE (UT), a Mobile Subscriber Station (MSS), a Subscriber Station (SS), an Advanced Mobile Station (AMS), or a Wireless UE (WT).

Referring to FIG. 25, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 24, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Example of a Vehicle or an Autonomous Driving Vehicle to which the Present Disclosure is Applied

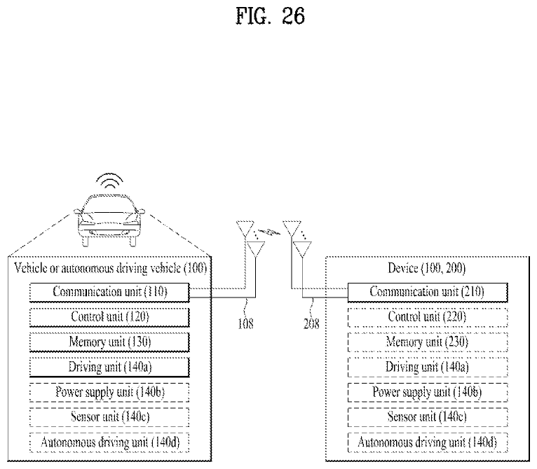

FIG. 26 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 26, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 24, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Examples of AR/VR and Vehicle to which the Present Disclosure is Applied

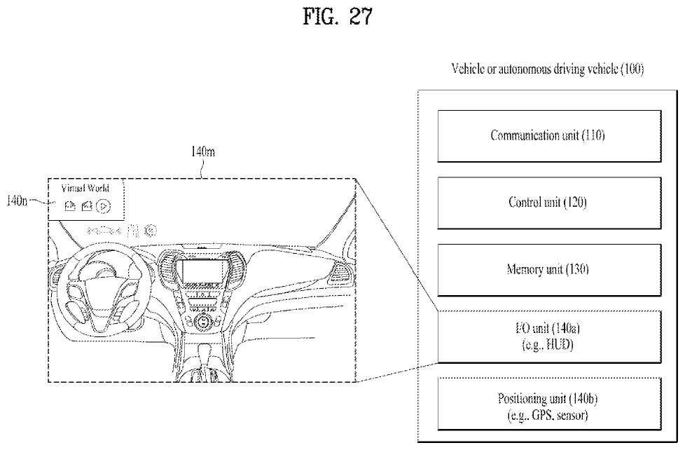

FIG. 27 illustrates a vehicle applied to the present disclosure. The vehicle may be implemented as a transport means, an aerial vehicle, a ship, etc.

Referring to FIG. 27, a vehicle 100 may include a communication unit 110, a control unit 120, a memory unit 130, an I/O unit 140a, and a positioning unit 140b. Herein, the blocks 110 to 130/140a and 140b correspond to blocks 110 to 130/140 of FIG. 24.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

Examples of XR Device to which the Present Disclosure is Applied

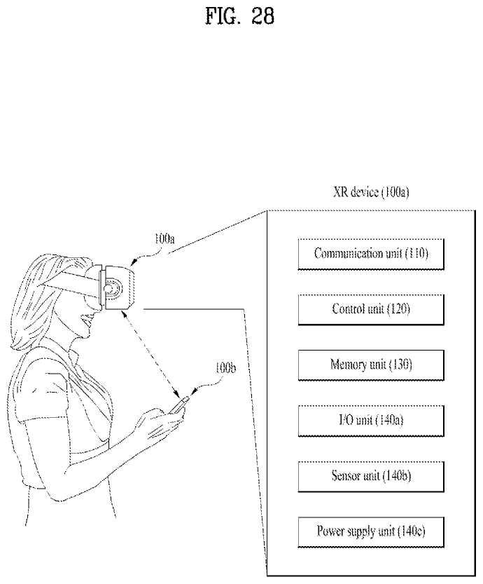

FIG. 28 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 28, an XR device 100a may include a communication unit 110, a control unit 120, a memory unit 130, an I/O unit 140a, a sensor unit 140b, and a power supply unit 140c. Herein, the blocks 110 to 130/140a to 140c correspond to the blocks 110 to 130/140 of FIG. 24, respectively.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

Examples of Robot to which the Present Disclosure is Applied

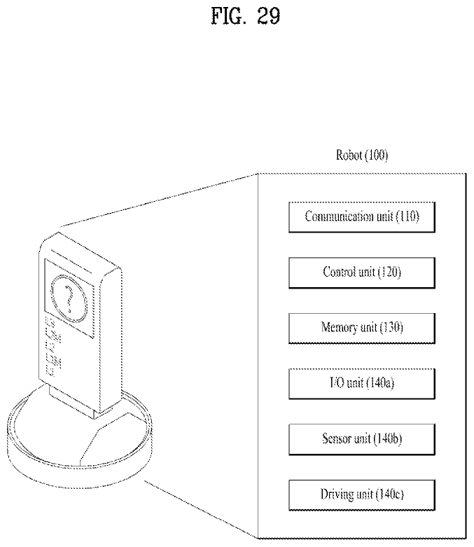

FIG. 29 illustrates a robot applied to the present disclosure. The robot may be categorized into an industrial robot, a medical robot, a household robot, a military robot, etc., according to a used purpose or field.

Referring to FIG. 29, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 24, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

Examples of AI Device to which the Present Disclosure is Applied

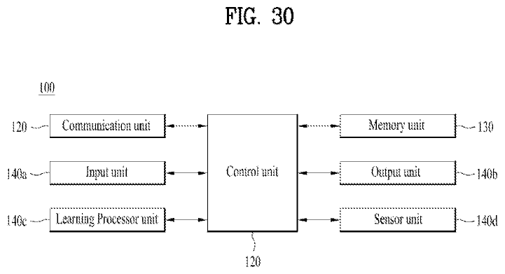

FIG. 30 illustrates an AI device applied to the present disclosure. The AI device may be implemented by a fixed device or a mobile device, such as a TV, a projector, a smartphone, a PC, a notebook, a digital broadcast UE, a tablet PC, a wearable device, a Set Top Box (STB), a radio, a washing machine, a refrigerator, a digital signage, a robot, a vehicle, etc.

Referring to FIG. 30, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 24, respectively.

The communication unit 110 may transmit and receive wired/radio signals (e.g., sensor information, user input, learning models, or control signals) to and from external devices such as other AI devices (e.g., 100x, 200, or 400 of FIG. 21) or an AI server (e.g., 400 of FIG. 21) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information that is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 21). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 21). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

### INDUSTRIAL APPLICABILITY

The above-mentioned embodiments of the present disclosure are applicable to various mobile communication systems.

What is claimed is:

1. A method for a UE operating in a wireless communication system, the method comprising:
receiving a configured grant from a serving cell; and
announcing radio link failure (RLF) with respect to the serving cell,
wherein the UE performs sidelink communication using the configured grant until receiving a new configured grant after the RLF.

2. The method of claim 1, further comprising starting a radio link failure recovery timer,
wherein the radio link failure recovery timer is stopped based on the new configured grant.

3. The method of claim 1, wherein the configured grant is released based on a release indication.

4. The method of claim 3, further comprising starting a radio link failure recovery timer,
wherein the radio link failure recovery timer is stopped based on the release indication.

5. The method of claim 1, further comprising starting a radio link failure recovery timer,
wherein the radio link failure recovery timer is stopped based on recovery of a radio link.

6. The method of claim 1, wherein the configured grant includes at least one of a configured grant type 1 and a configured grant type 2.

7. The method of claim 1, wherein the UE operates in a resource allocation mode 1.

8. The method of claim 1, wherein the UE switches to a resource allocation mode 2 when radio link recovery fails after the RLF.

9. The method of claim 1, wherein the UE releases the configured grant when radio link recovery fails after the RLF.

10. A UE in a wireless communication system, comprising:
at least one processor; and
at least one computer memory operably coupled to the at least one processor and storing instructions that, when executed, cause the at least one processor to perform operations;
wherein the operations comprise:
receiving a configured grant from a serving cell; and
announcing radio link failure (RLF) with respect to the serving cell,
wherein the UE performs sidelink communication using the configured grant until receiving a new configured grant after the RLF.

11. The UE of claim 10, wherein the UE communicates with at least one of another UE, a UE related to an autonomous vehicle, a base station or a network.

12. A processor for performing operations for a UE in a wireless communication system,
wherein the operations comprise:
receiving a configured grant from a serving cell; and
announcing radio link failure (RLF) with respect to the serving cell,
wherein the UE performs sidelink communication using the configured grant until receiving a new configured grant after the RLF.

13. A computer-readable storage medium storing at least one computer program including instructions that, when executed by at least one processor, cause the at least one processor to perform operations for a UE,
wherein the operations comprise:
receiving a configured grant from a serving cell; and
announcing radio link failure (RLF) with respect to the serving cell,
wherein the UE performs sidelink communication using the configured grant until a new configured grant is received after the RLF.
